(19) United States
(12) Patent Application Publication
(10) Pub. No.: US 2016/0361688 A1
(43) Pub. Date: Dec. 15, 2016

(54) RADIATIVE EXCITATION OF METHANE FOR REDUCED TEMPERATURE EMISSION CONTROL

(71) Applicant: Southwest Research Institute, San Antonio, TX (US)

(72) Inventors: Gordon J.J. BARTLEY, San Antonio, TX (US); Ralph Henry HILL, JR., San Antonio, TX (US)

(21) Appl. No.: 14/736,529

(22) Filed: Jun. 11, 2015

(51) Int. Cl. B01D 53/94

(52) U.S. Cl. CPC B01D 53/94; B01D 2255/1021; B01D 2255/1025; B01D 2255/1023; B01D 2258/018

(57) ABSTRACT

The present invention relates to excitation of hydrocarbons for catalytic type oxidation reactions, and more particularly, to treatment of excess methane emissions in a natural gas fueled engine to promote relatively more efficient catalytic methane oxidation reactions.

### TECHNICAL FIELD

The present invention relates to excitation of hydrocarbons for catalytic type oxidation reactions, and more particularly, to treatment of excess methane emissions in a natural gas fueled engine to promote relatively more efficient catalytic methane oxidation reactions.

### BACKGROUND INFORMATION

Natural Gas (NG) has become significantly more abundant with the advent of hydraulic fracturing technologies. So much so that it is a burgeoning fuel for internal combustion engines with major advantages of relatively low cost and reduced CO₂ emissions. Unfortunately, the primary component of NG is methane (CH₄), which has a high Global Warming Potential (GWP) value of 34. Excessive CH₄ emissions from these engines will eliminate the advantage of reduced CO₂, and may increase the exhaust GWP relative to gasoline or diesel engines. Therefore controlling CH₄ emissions is of considerable importance.

Unfortunately, catalytic oxidation of methane to CO₂ and water requires elevated temperatures in excess of 300° C. because breaking of the first C—H bond requires a relatively high energy of about 427 kJ/mol. The preferred catalysts for CH₄ oxidation also have durability issues like sulfur poisoning, that increase light-off temperatures (i.e. the temperature at which a catalytic reaction is initiated) even more. The challenge becomes substantial when taking into account the trend toward (1) lower exhaust gas temperatures and (2) improved efficiency engines needed to meet the future fleet average fuel economy standard of 54.5 miles per gallon for cars and light-duty trucks by 2025.

Accordingly, there is a need for developing processes to treat methane powered engine exhaust emissions to lower the GWP value and the temperature required to treat the exhaust as well as augmenting the life time of the catalyst.

### SUMMARY OF THE INVENTION

An apparatus and a method for oxidizing methane contained in a methane gas engine exhaust stream. An engine exhaust stream is provided that includes methane (CH₄) and oxygen where the methane in the exhaust stream is energized and there is promotion of one of a C—H stretching or bending response. The exhaust stream containing the energized methane is exposed to a catalytic oxidation reaction where the methane is oxidized to produce one of carbon dioxide (CO₂) or carbon monoxide (CO) and the methane oxidation occurs at a temperature of less than or equal to 350° C.

### BRIEF DESCRIPTION OF THE DRAWINGS

These and other features and advantages will be better understood by reading the following detailed description, taken together with the drawings wherein:

FIG. 1 illustrates the vibration or bending excitation of methane that may be employed to reduce the energy needed for catalytically breaking the C—H bond therein for ensuing reaction.

FIG. 2 is the infrared (IR) spectrum of methane identifying the relevant asymmetric stretch and asymmetric bend of methane.

FIG. 3 is a schematic representation of an apparatus and process of the present invention illustrating laser radiation activation of excess methane in a natural gas engine prior to introduction to the catalytic converter.

FIG. 4 is a schematic representation of an apparatus and process according to the present invention illustrating laser radiation activation of excess methane in a natural gas engine directly within the catalytic converter housing.

FIG. 5 is a schematic representation of an apparatus and process according to the present invention illustrating laser radiation activation of excess methane in a natural gas engine both prior to introduction into the catalytic converter and simultaneously within the catalytic converter.

### DETAILED DESCRIPTION

The present disclosure is directed at both an apparatus and process that energizes or excites the C—H bond in a hydrocarbon so that ensuing reactions, such as catalytic oxidation reactions, proceed with relatively reduced energy demands and at reduced temperatures. Such excitation may be achieved by application of radiation at a selected frequency and/or by use of a collision partner, which is reference to collision of the hydrocarbon with an energized or excited partner molecule. It is contemplated that the present invention will therefore provide control of emissions from engines operating with hydrocarbon fuels with an improvement in the associated environmental impact of engine exhaust output.

The exemplary hydrocarbon fuel for such process is the methane (CH₄) molecule and the exemplary reaction that can now be facilitated is oxidation of methane to carbon dioxide and water. The exemplary environment for such an apparatus and process is the catalytic converter in a natural gas engine where methane may be a component of the engine exhaust.

A natural gas engine herein may therefore be understood as an engine that operates on natural gas fuel, where a natural gas fuel includes gases containing 30% or more by volume of methane. Such natural gas fuel may be sourced from mineral sources such as natural gas wells or from gasification of biomass, or from coal gasification processes, from landfill sites or produced by hydrogenation of carbon oxides or other methane forming procedures.

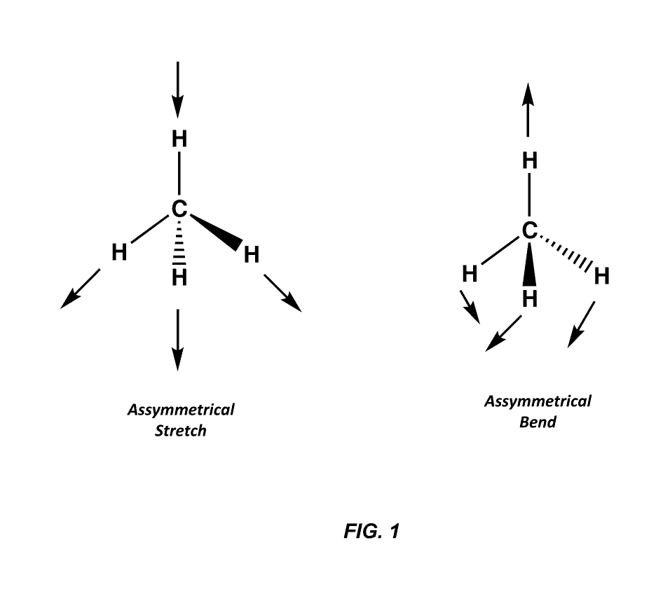

FIG. 1 identifies that in the case of methane gas one may have: (1) CH₄ asymmetric stretching at 3019 cm⁻¹ (wavelength of 3.31 μm), with a full width at half maximum at 2900 cm⁻¹ to 3150 cm⁻¹ (3.17 μm-3.49 μm); and (2) CH₄ asymmetric bending at 1306 cm⁻¹ (wavelength of 7.65 μm), with a full width at half maximum at 1250 cm⁻¹ to 1350 cm⁻¹ (7.41 μm-8.0 μm). Note that these data are for laboratory measurements of 150 Torr of methane, diluted to a total pressure of 600 Torr with nitrogen. Actual wavelengths may be somewhat different due to temperature and pressure effects. See, NIST Mass Spec Data Center, S. E. Stein, director, “Infrared Spectra” in NIST Chemistry WebBook, NIST Standard Reference Database Number 69, Eds. P. J. Linstrom and W. G. Mallard, National Institute of Standards and Technology, Gaithersburg Md., 20899, http://webbook.nist.gov. Accordingly, excitation with radiation at a selected frequency to energize or excite one or more of these C—H bonds will necessarily reduce the energy required to catalytically break the C—H bond by a proportionate amount. Accordingly, the excitation with radiation may be initially applied herein to provoke any one or more of the above mentioned hydrocarbon C—H stretching or bending responses to promote an ensuing catalytic reaction of the hydrocarbon (e.g. methane) substrate.

That is, the reduction in energy needed to break the C—H bond is now specifically relied upon to provide a corresponding reduction in the temperature at which CH₄ oxidation occurs in the presence of a suitable catalyst. Accordingly, this may be illustrated by the following sequence in the case where as an example, radiation is selectively applied to provoke asymmetrical C—H stretching following by total CO₂ oxidation:

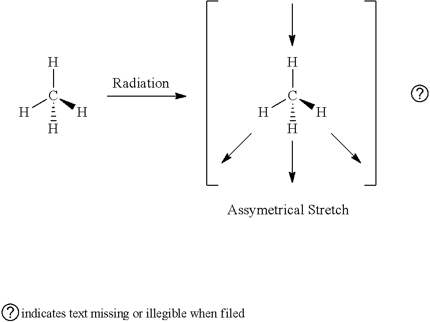

It may be appreciated that in the above, the energy required to break the first C—H bond in methane is about 427 kJ/mole. By application of radiation it can be appreciated that the additional energy necessary to break the first C—H bond will be less than 427 kJ/mole. Accordingly, it can be appreciated that with respect to methane oxidation, the present disclosure provides radiation treatment such that in an ensuing reaction of methane, such as in catalytic oxidation, the energy to break the first C—H bond will be less than 427 kJ/mole, or in the range of 213 kJ/mole to less than 427 kJ/mole.

It can now also be appreciated that the selective activation of the C—H bonds herein are effectively exploited in an oxidation reaction, including, but not limited to the following, wherein the reaction noted is preferably catalyzed and the excitation and weakening of the C—H bond by the above referenced radiation permits the indicated reactions to proceed at lower relative temperatures as compared to that situation where the weakening by radiation is not applied:

CH₄+2O₂→CO₂+2H₂O Total Oxidation

CH₄+0.5O₂→CO+2H₂ Partial Oxidation

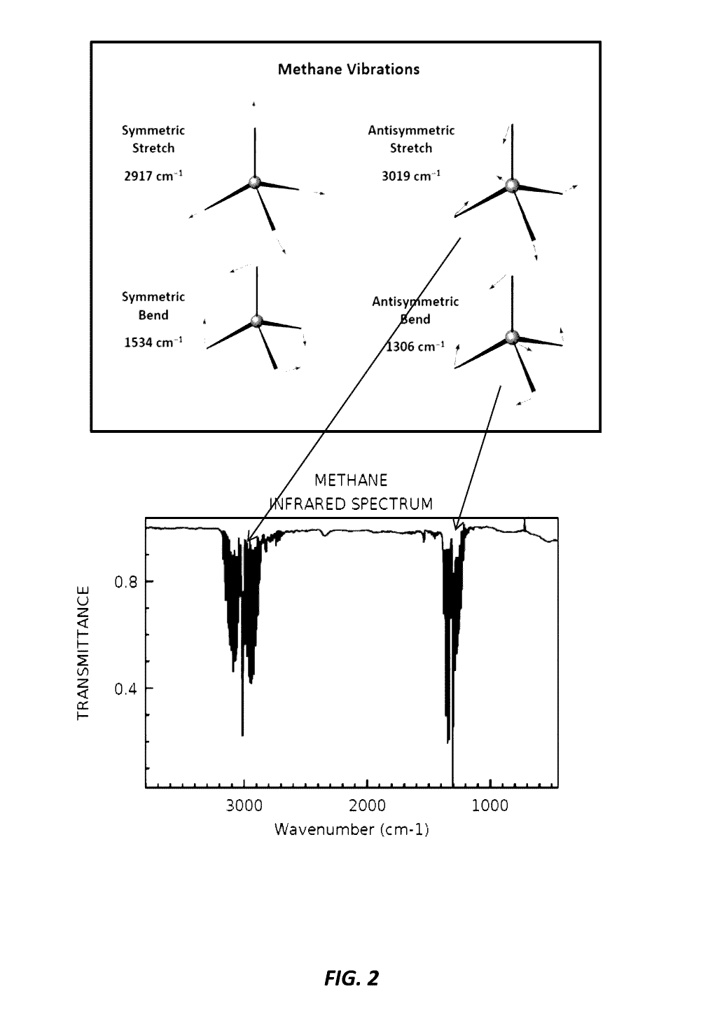

The radiation that is suitable for excitation and weakening of the C—H bond as noted herein may be obtained from a number of sources. Preferably, one can employ infrared (IR) light treatment, and more specifically, infrared light emitting diodes (IRLEDs) or infrared lasers. For example, a suitable wavelength may be selected to trigger any one or more of the methane stretch and bend wavelengths noted above. Accordingly, IR laser light treatment can be applied and preferably, over the range of 1306 cm⁻¹ (wavelength of 7.65 μm) to 3200 cm⁻¹ (wavelength of 3.13 μm). Either of these regions could be used where CH₄ has a relatively strong absorption due to asymmetric C—H stretching or bending, as seen in the spectrum shown in FIG. 2. Accordingly, one may preferably utilize IR laser light in the range of 2.85 μm (3500 cm⁻¹) to 4.0 μm (2500 cm⁻¹ wavenumbers).

Other sources for radiation and activation of the C—H bond include solid state quantum cascade lasers (QCL) that are semiconductor lasers that emit in the infrared portion of the electromagnetic spectrum (wavelength range from 2.0 μm to 250 μm). One may also utilize a distributed feedback laser (DFL) which is a type of laser diode, quantum cascade laser or optical fiber laser where the active region of the device is periodically structured as a diffraction grating. The structure builds a one-dimensional interference grating (Bragg scattering) and the grating provides optical feedback for the laser. In addition, one may employ an interband cascade laser (ICL) which is also a type of laser diode that can produce radiation over the infrared portion of the electromagnetic spectrum.

It is also worth noting that the present disclosure, which utilizes the above referenced radiation, is more selective and relatively more efficient than the use of plasma excitation. That is the present process herein of irradiating the methane by use of laser treatment does not rely upon the use of plasma excitation, which typically involves the use of a relatively strong and broadly applied electric field and the formation of an ionized gas.

It can also be noted that one can evaluate the power of any applicable laser that may be required herein to achieve selective excitation of the applicable methane infrared vibrational mode (see again FIG. 1). This may be accomplished by considering the number of photons produced:

Number of photons/sec=Power×Wavelength/hc

where h is Plank's constant and c is the speed of light. Accordingly, for a 30 mW laser or LED operating at 3.31 μm, the number of photons would be about 4.8×10¹⁷ photons/sec. The number of methane molecules in a given interaction zone (i.e. the region in which the methane is exposed to laser energy) can be estimated using Loschmidt's number at STP which yields about 1.9×10¹⁹ molecules/cm³. Loschmidt's number is reference to the number of particles (atoms or molecules) of an ideal gas in a given volume. Thus, if the LED or laser is focused into a volume of a cubic centimeter and the dwell time is one second, about two percent of the methane molecules will be activated if a probability of excitation of 80% is assumed since this is a resonant or near-resonant process. In the context of the present disclosure, while it is useful to activate any amount of methane, it is preferable that the percentage of methane molecules within a given activation zone for ensuing catalytic oxidation is in the range of greater than or equal to 10% up to 100%, which will depend upon the power output of the laser source that is ultimately selected. In addition, it should be noted that while the activation of the methane herein can be accomplished at standard temperature and pressure, it can be appreciated that one may increase temperature or pressure in which case the proportion of methane molecules that are excited will be increased. Accordingly, it is contemplated that the excitation of the methane herein may be accomplished at temperatures from ambient temperature (25° C.) to temperatures of 350° C., more preferably at temperatures of 150° C. to 350° C., as well as at 150° C. to 250° C. and at pressures from standard pressure (14.5 psia) to pressures of 20 psia.

It should also be noted that the radiation source here, such as the use of an infrared type laser, may be either in continuous mode or in pulsed operation. Pulsed operation is reference to the feature that the power output appears in pulses of some selected duration at some repetition rate. This is particularly of benefit in the case of those lasers that are not generally suitable for continuous mode operation. As the pulse energy of the laser is equal to the average power divided by the repetition rate, delivery of some relatively large amount of energy can be achieved by lowering the rate of pulses so that more energy may be built-up between pulses. That is, by application of relatively large amount of energy in a given pulse, one may selectively activate the methane molecule according to any one or more of the activated states as shown in FIG. 1, while allowing for any generated heat to be absorbed into the bulk of the hydrocarbons and other gaseous components that may be present. Additionally, the wavelength of the laser may be rapidly modulated so as to align with the various resonances available in the molecular-vibrational manifold. This modulation could be preferably done at 1 KHz. Accordingly the wavelength of the laser may be changed so that it can be specifically altered to identify the appropriate wavelength for methane activation.

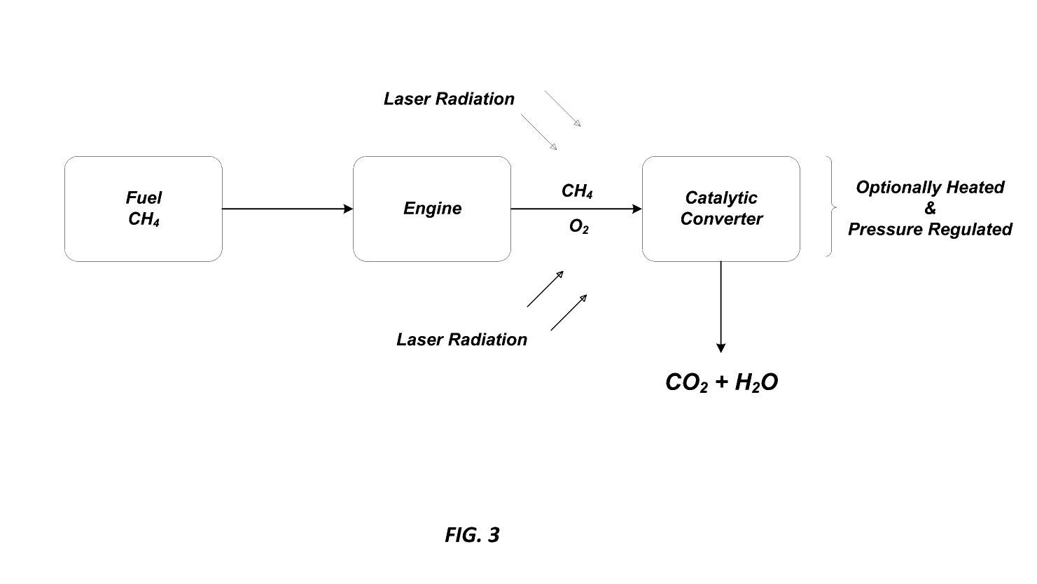

As noted above, since natural gas has become a potential problem with respect to emission of a natural gas engine, the need to control methane emissions resulting from incomplete combustion can now be facilitated by activating the C—H bond in methane as noted above, to improve the efficiency of the ensuing catalytic oxidation reaction. FIG. 3 illustrates that in the case of a natural gas combustion engine, one may now provide for laser radiation to any methane exhaust output and upon introduction of oxygen, introduce the activated methane to a catalytic converter to promote methane oxidation. Accordingly, the laser radiation may be introduced prior to the methane entering the catalytic converter. As the C—H bond in methane is now selectively activated due to the laser radiation treatment, the ensuing catalytic oxidation with the conversion of methane to carbon dioxide and water can now proceed at the relatively lower temperatures noted herein.

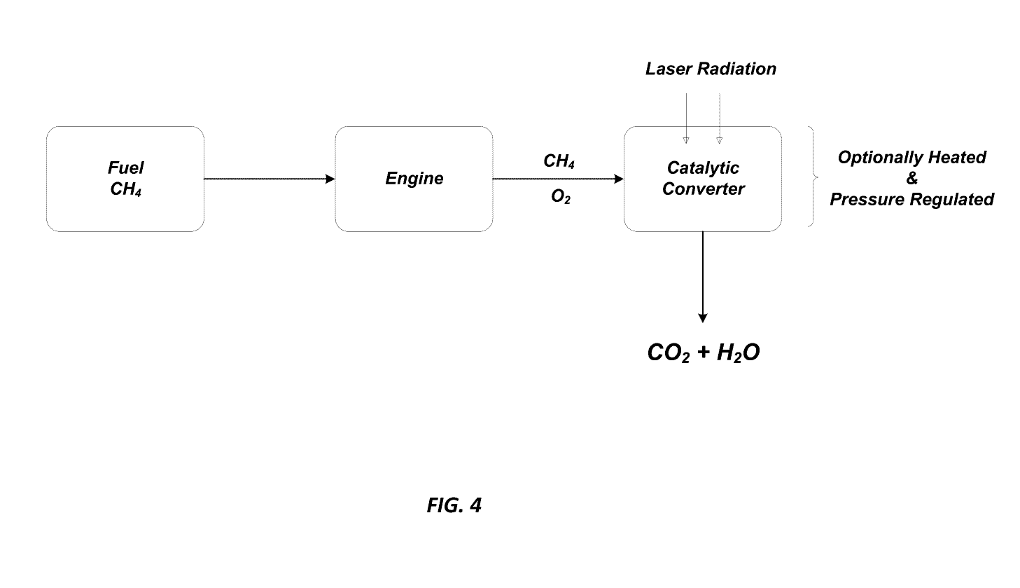

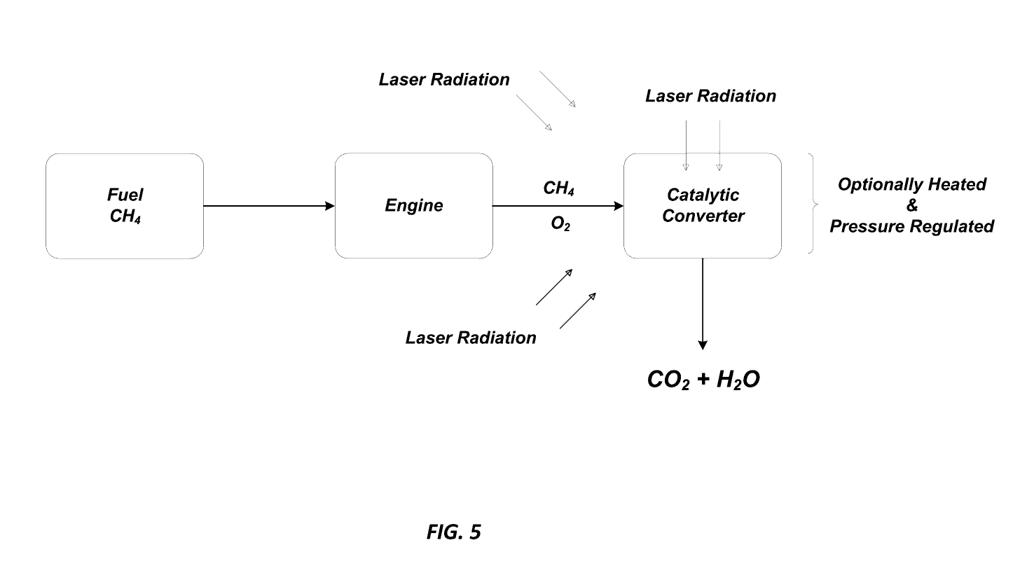

FIG. 4 illustrates another contemplated configuration for the catalytic converter of FIG. 3. As illustrated, one may elect to provide for laser radiation directly within the catalytic converter housing to selectively activate and weaken one or more of the C—H bonds in methane for ensuing catalytic oxidation. FIG. 5 illustrates yet another optional configuration wherein the laser radiation may be provided to the exhaust gas of a natural gas engine both prior to introduction into the catalytic converter and simultaneously, within the catalytic converter, to further optimize (i.e. increase) the amount of C—H bonds that are activated for catalytic oxidation. In addition, it is contemplated that the activation of the C—H bond in methane prior to introduction into the catalytic converter may target the activation of only one particular C—H absorption mode, such as asymmetric stretching at 3019 cm⁻¹ (wavelength of 3.31 μm) and the laser radiation introduced within the catalytic converter may provide for activation of the same or a different C—H absorption mode, such as only CH₄ asymmetric bending at 1306 cm⁻¹

As noted above, each one of these plurality of locations for laser activation may target the activation of one or more C—H activation modes, noted herein. That is, each of these plurality of locations for radiation activation, three of which as shown in FIG. 5, can be configured to activate the same or different asymmetrical C—H stretching or bending which are illustrated in FIG. 1.

A suitable catalyst for methane oxidation herein may be a three-way catalyst capable of simultaneous oxidation of hydrocarbons (HC) and carbon monoxide (CO) and reduction of oxides of nitrogen (NO_{X}) under stoichiometric, perturbed engine operating conditions. It may also be a dedicated oxidation catalyst used to oxidize HC and CO under lean engine operating conditions. Such catalysts typically contain active metals such as platinum (Pt) and rhodium (Rh) and especially palladium (Pd) which is particularly active for CH₄ oxidation. It is contemplated that excitation of CH₄ in the presence of any such catalyst therefore will now result in relatively higher CH₄ oxidation conversion efficiency under fixed conditions, and/or a lowering of the temperature required to initiate CH₄ oxidation.

In addition, it should be noted that the catalyst may be mixed or coated on a substrate such as alumina, ceria, zirconia, glass beads or ceramics, with optionally barium or strontium. The substrate may be micro- or nano-particulate and also transparent to radiation, such as infrared light, in order to facilitate the radiation activation disclosed herein. That is, the substrate for supporting the catalyst may be configured such that it will allow for transmission of infrared radiation so that the methane, when in contact with a given catalyst, is activated in the manner disclosed, e.g., as shown in FIG. 1.

In another embodiment, it is contemplated that collision partners may be directly excited upstream of the methane oxidation catalyst or within the catalytic converter. When the lifetime of such collision partner is long enough then the catalytic reaction may occur within the catalyst with an excited state of the methane, due to collision with the excited partner molecule. For instance, there are metastable oxygen states which are known to have a relatively long-lived metastable-state lifetime. Specifically, one may selectively form the singlet oxygen state of oxygen (O₂*) which can be present for time periods of up to many seconds at room temperature. Similarly, one may also rely upon activated nitrogen (sometimes referred to as “active nitrogen.”).

Singlet oxygen may be understood as the lowest excited state of the dioxygen molecule. It is therefore contemplated herein that production of O₂* may now be relied upon in the following reaction sequence where the activated oxygen collides with methane:

O₂*+CH₄→Activated CH₄

The activated CH₄ includes the activated configurations of methane illustrated in FIG. 1. The methane, so activated, can then undergo catalytic oxidation at relatively reduced temperatures (<350° C.) as noted above, and again, preferably in the range of 150° C. to 350° C., as well as at 150° C. to 250° C. and at pressures from standard pressure (14.5 psi) to pressures of 200 psi.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method for oxidizing methane contained in a methane gas engine exhaust stream, comprising:
supplying an engine exhaust stream that includes methane (CH₄) and oxygen;
energizing the methane in said exhaust stream and promoting one of a C—H stretching or bending response;
exposing the exhaust stream containing said energized methane to a catalytic oxidation reaction where said methane is oxidized to produce one of carbon dioxide (CO₂) or carbon monoxide (CO) wherein said oxidation occurs at a temperature of less than or equal to 350° C.

2. The method of claim 1 wherein said energizing said methane comprises irradiating of methane by an infrared laser where said infrared laser outputs light at a wavelength in the range of 3.13 μm to 8.34 μm.

3. The method of claim 2 wherein said irradiating of methane comprises application of an infrared laser wherein said infrared laser outputs light at a wavelength of 2.0 μm to 4.0 μm.

4. The method of claim 1 wherein said C—H stretching comprises one of:
(a) CH₄ asymmetric stretching at 3019 cm⁻¹ (wavelength of 3.31 μm); or
(b) CH₄ asymmetric bending at 1306 cm⁻¹ (wavelength of 7.65 μm).

5. The method of claim 1 wherein said oxidation reaction comprises at least one of the following reactions:
(a) CH₄+2O₂→CO₂+2H₂O
(b) CH₄+0.5O₂→CO+2H₂

6. The method of claim 2 where said irradiating of said exhaust stream is provided by one of an infrared light emitting diode, infrared laser, quantum cascade laser or distributed feedback laser.

7. The method of claim 2 wherein said engine exhaust stream flows into a catalytic converter for said catalytic oxidation reaction, and said irradiating of said exhaust stream occurs prior to said exhaust stream flowing into said converter.

8. The method of claim 2 wherein said exhaust stream flows into a catalytic converter for said catalytic oxidation reaction and said irradiating of said exhaust stream occurs within said catalytic converter.

9. The method of claim 2 wherein said exhaust stream flows into a catalytic converter for said catalytic oxidation reaction and said irradiating of said exhaust stream occurs prior to and within said catalytic converter.

10. The method of claim 9 wherein said irradiating of said exhaust stream prior to said catalytic converter comprises irradiating at one selected frequency and irradiating of said exhaust stream within said catalytic converter occurs at a different selected frequency.

11. The method of claim 1 wherein said methane catalytic oxidation occurs at a temperature of 150° C. to 350° C.

12. The method of claim 1 wherein said methane catalytic oxidation occurs at a temperature of 150° C. to 350° C.

13. The method of claim 1 wherein said catalytic oxidation reaction comprises treatment of said energized methane to one of platinum, rhodium, or palladium.

14. The method of claim 1 comprising energizing said methane by colliding methane with an energized partner molecule.

15. The method of claim 14 wherein said energized partner molecule comprises singlet oxygen.

16. An exhaust stream treatment apparatus for a natural gas fueled engine which outputs methane comprising:
a catalytic converter for methane oxidation;
a source for energizing methane to promote one of a C—H stretching or bending response;
wherein said catalytic converter is capable of oxidizing methane in said exhaust stream to produce one of carbon dioxide (CO₂) or carbon monoxide (CO) wherein said oxidation occurs at a temperature of less than or equal to 350° C.

17. The exhaust stream apparatus of claim 16 where said source for energizing methane comprises an infrared laser wherein said infrared laser outputs light at a wavelength of 2.85 μm to 4.0 μm.

18. The exhaust stream apparatus of claim 17 where said source for energizing methane comprises one of an infrared light emitting diode, infrared laser, quantum cascade laser or distributed feedback laser.

19. The exhaust stream apparatus of claim 18 wherein said source for energizing methane comprises colliding methane with an energized partner molecule.
